(19) United States
(12) Patent Application Publication
(10) Pub. No.: US 2007/0185257 A1
(43) Pub. Date: Aug. 9, 2007

(54) Directly metallizable polyester molding compound

(75) Inventors: Roland Wursche, Dulmen (DE); Hans-Gunter Lohkamper, Haltern am See (DE); Frank Lorenz, Olfen (DE); Alexander Richter, Oer-Erkenschwick (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: Degussa AG, Duesseldorf (DE)

(21) Appl. No.: 10/588,771

(22) PCT Filed: Jul. 15, 2005
(86) PCT No.: PCT/EP05/53416

§ 371 Date: Aug. 8, 2006

(30) Foreign Application Priority Data
Jul. 23, 2004 (DE) 10 2004 035 835.4

(51) Int. Cl. C08L 67/00

(52) U.S. Cl. 524/539

(57) ABSTRACT

A molding compound which comprises the following components: I. 50 to 99.98 parts by weight of thermoplastic polyesters, II. 0.02 to 5 parts by weight of a copolymer which contains polysiloxane blocks and polyester blocks, III. 0 to 49.98 parts by weight of further adjuvants, selected from further polymers, fillers and pigments, antistats, reinforcing agents, and stabilizers, the sum of all the parts by weight making 100, is used for producing metallized moldings.

The invention relates to a polyester molding compound which yields moldings having good demoldability and metallizability.

The direct metallizing of components of the headlamp housing in the automotive sector, such as surrounds, reflectors or trim rings, for example, or else parts of other reflecting lights, e.g., indicators, is increasingly gaining in importance, since it allows a considerable saving to be made in production costs. The reasoning underlying this is that an otherwise necessary intermediate step, namely that of coating the component prior to its metallization, can be omitted. This not only lowers material costs and reduces the processing time of the component but also eliminates one possible error source in the operating chain. On the other hand, a prerequisite is that the surface of the component itself must satisfy exacting requirements in terms of surface quality, since with the coating absent there is no longer any possibility for defects to be “toned down”. For this reason, unreinforced molding compounds are suitable in particular, but must in turn ensure high heat distortion resistance at high operating temperatures. Polyester molding compounds, based for example on polybutylene terephthalate (PBT), are suitable in principle for this application.

With molding compounds of this kind it is important that any additives present are unable to migrate at high temperatures through the metallic layer, which would result, during the service life, in the development of clouding, misting or rainbow effects. The first two cases often involve whitish deposits, which lead to a reduction in the amount of light reflected and impair the functioning of the component accordingly. The final case involves an unwanted color effect at an observation angle of 10° to 90°, which derives from light being refracted differently as a function of wavelength. The sublimation of migrating substances may also result in the deleterious formation of deposits throughout the interior of a headlamp. In particular, a mold release agent is needed that does not lead to such defects developing.

EP 1 298 172 A1 proposes, in metallizable PBT molding compounds, using polymeric mold release agents that have been synthesized from olefinic building blocks. Described as being particularly suitable therein are compositions in which the polymeric mold release agent is composed of polyethylene. A satisfactory balance between the molding-compound properties that are required, however, cannot be obtained in this way. The effect of a mold release agent derives from its being present in effective concentration at the parting line between molding compound and injection mold, and lowering the adhesion between the material and the wall of the mold; in the ideal case, a coherent film is realized. At low polyolefin concentration, the surface is not uniformly covered and, following metallization, interfering structures are visible on the surface; in addition, demoldability is inadequate. At higher concentrations, which produce a coherent film, and, in tandem with this, where demoldability is good, the incompatibility with the matrix material results in said film adhering poorly to the polyester molding compound and hence resulting, in industrial operation, in the formation of fouling within the injection mold, which is undesirable on account of the cleaning effort involved. Moreover, adhesion of the metallization to the component is adversely affected.

WO 02/92688 describes the addition of a polysiloxane for this application. In that case, however, the same problems occur as when using polyethylene. Similar systems are described in JP-A 11061382 and JP-A 11241006; there, a blend of polyester and polycarbonate is admixed with a modified silicone oil that contains functional groups such as epoxy groups, for example, via which attachment to the polymer matrix is intended. Experience has shown, however, that any such reaction with the few polyester end groups is always incomplete, and so there are considerable concentrations of low molecular mass compounds present which lead, at high service temperatures, to instances of outgassing, with the disadvantages described above.

The object of the present invention was to develop a directly metallizable polyester molding compound affording good adhesion of the metallization to the molding, with the aims being to optimize the deformability and also the surface quality of the metallization. The intention was that this should be achieved while at the same time avoiding instances of deposition in the injection mold.

The object is achieved through the use of a molding compound, for producing metallizable moldings, which comprises the following components:
I. 50 to 99.98 parts, preferably 80 to 99.9 parts, and more preferably 90 to 99.8 parts by weight of thermoplastic polyesters,
II. 0.02 to 5 parts, preferably 0.1 to 3 parts, and more preferably 0.2 to 2.5 parts by weight of a copolymer which contains polysiloxane blocks and polyester blocks, preferably polysiloxane blocks and polylactone blocks,
III. 0 to 49.98 parts, preferably 0.1 to 20 parts, and more preferably 0.3 to 10 parts by weight of further adjuvants, selected from further polymers, fillers and pigments, antistats, reinforcing agents, and stabilizers,
   the sum of all the parts by weight making 100.

Thermoplastic polyesters are prepared by polycondensation of diols with dicarboxylic acids and/or their polyester-forming derivatives such as dimethyl esters. Suitable diols have the formula HO—R—OH, where R is a divalent, branched or unbranched, aliphatic and/or cycloaliphatic radical having 2 to 40, preferably 2 to 12, carbon atoms. Suitable dicarboxylic acids have the formula HOOC—R′—COOH, where R′ is a divalent aromatic radical having 6 to 20, preferably 6 to 12, carbon atoms.

Examples that may be mentioned of diols include ethylene glycol, trimethylene glycol, tetramethylene glycol, 2-butene-1,4-diol, hexamethylene glycol, neopentyl glycol, cyclohexanedimethanol, and the C₃₆ diol dimer diol. The diols can be used alone or as a diols mixture.

Examples of suitable aromatic dicarboxylic acids include terephthalic acid, isophthalic acid, 1,4-, 1,5-, 2,6-, and 2,7-naphthalenedicarboxylic acid, diphenic acid, and diphenyl ether 4,4′-dicarboxylic acid. Up to 30 mol % of these dicarboxylic acids can be replaced by aliphatic or cycloaliphatic dicarboxylic acids having 3 to 50 carbon atoms and preferably having 6 to 40 carbon atoms, such as succinic acid, adipic acid, sebacic acid, dodecanedioic acid or cyclohexane-1,4-dicarboxylic acid, for example.

Furthermore, the thermoplastic polyester of the molding compound of the invention can be prepared by converting cyclic oligomers of the polyester into linear polyesters in an entropy-driven or catalyzed ring-opening polymerization. This can take place, for example, in the injection mold in the manner of an RIM process. An advantage of this procedure is that the polyester in its low molecular mass form has very good fluidity, which may be of advantage in the case of complex components but also in the case of highly filled molding compounds. EP-A-0 699 701 and U.S. Pat. No. 5,231,161 describe two methods of preparing macrocycles, while EP-A-0 725 098, EP-A-0 749 999, and U.S. Pat. No. 5,039,783 disclose the polymerization of macrocycles to give high molecular mass polyester.

Examples of suitable polyesters are polyethylene terephthalate, polypropylene terephthalate, polybutylene terephthalate, polyethylene 2,6-naphthalate, polypropylene 2,6-naphthalate, and polybutylene 2,6-naphthalate. It will be appreciated that mixtures of different polyesters can also be used.

The preparation of these polyesters is prior art (DE As 24 07 155 and 24 07 156; Ullmanns Encyclopädie der technischen Chemie, 4th ed., vol. 19, pages 65 ff., Verlag Chemie, Weinheim, 1980).

If required, in accordance with the prior art, the polyester can be subjected to solid-phase postcondensation in a stream of inert gas or under reduced pressure, generally at a maximum temperature of 5 K and preferably of 10 K below the crystallite melting point, over a period of 2 hours to 3 days.

The polyester used, or the polyester mixture used if desired, generally possesses a solution viscosity J, measured in accordance with DIN 53728/ISO 1628-Part 5, in a 0.5% strength by weight phenol/o-dichlorobenzene solution (weight ratio 1:1) at 25° C., of at least 80 cm³/g, preferably of at least 90 cm³/g, and more preferably of at least 100 cm³/g.

The copolymer that contains polysiloxane blocks and polyester blocks acts as a mold release agent. The polyester blocks are composed, for example, of polyethylene terephthalate, polypropylene terephthalate, polybutylene terephthalate, polyethylene 2,6-naphthalate, polypropylene 2,6-naphthalate, polybutylene 2,6-naphthalate, or a polylactone such as polycaprolactone, for example.

The copolymer containing polysiloxane blocks and polylactone blocks customarily has the formula 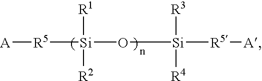
where n is an integer from 1 to about 200 and preferably from 10 to about 150; R¹, R², R³, and R⁴, independently of one another, are a linear or branched alkyl radical having 1 to 6 carbon atoms;
A and A′, independently of one another, are units of the formula 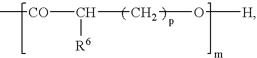
   where p is an integer from 0 to 6; m is an integer from 1 to about 250 and preferably from 10 to about 200;
R⁶ is hydrogen or a linear or branched alkyl group having 1 to 6 carbon atoms;
R⁵ is selected from —(CH₂)_{q}—O—, —(CH₂)_{q}—NH—, —(CH₂)ₜ—O—(CH₂CH₂O)ᵥ—CH₂CH₂O—, and —(CH₂)ₜ—O—(CH₂CH₂O)ᵥ—CH₂CH₂NH—,
R⁵′ is selected from —O—(CH₂)_{q}—, —NH—(CH₂)_{q}—, —OCH₂CH₂—(OCH₂CH₂)ᵥ—O—CH₂)ₜ—, and —HNCH₂CH₂—(OCH₂CH₂)ᵥ—O—(CH₂)ₜ—,
   where q is an integer from 1 to 20,
      t is an integer from 1 to 6, and
      v is an integer from 1 to 100, preferably from 2 to 40.

Corresponding block copolymers are known from WO 86/04072. They are commercially customary, for example, under the trade name Tegomer® H-Si6440 (Goldschmidt AG, Essen, Germany). Also suitable, furthermore, are the copolymers known from EP 1 211 277 A2, which contain polysiloxane blocks, polyester blocks, and polyolefin blocks.

Generally speaking, the copolymer of component II contains 1%-99%, preferably 5%-95%, more preferably 10%-90%, and with particular preference 15%-85% by weight of polyester blocks and also 1%-99%, preferably 5%-95%, more preferably 10%-90%, and with particular preference 15%-85% by weight of polysiloxane blocks.

The additives collated under component III are state of the art for polyester molding compounds; they are briefly elucidated below.

Further polymers are, for example, impact modifiers that are customary for polyesters, such as ethylene/α-olefin copolymers (especially EPM and EPDM) or styrene-ethylene/butylene block copolymers (especially SEBS), the impact modifier in all of these cases additionally carrying functional groups such as acid anhydride, for example, or else α-olefin/acrylic ester terpolymers with an olefinically unsaturated acid anhydride, glycidyl acrylate or glycidyl methacrylate as the ter component, and also, furthermore, different polymers such as, for example, polycarbonates, (meth)acrylate homopolymers and copolymers, styrene-acrylonitrile copolymers, acrylonitrile-butadiene-styrene copolymers (ABS) or branched polymers such as branched polyesters or polyamine-polyamide graft copolymers (EP 1 217 039 A2) for enhancing flow properties;

fillers and pigments are, for example, carbon black, titanium dioxide, iron oxide, glass beads, hollow glass beads, talc, zinc sulfide, silicates or carbonates, it also being possible for the fillers to be nanoscale;

reinforcing substances are, for example, glass fibers, carbon fibers, aramid fibers or whiskers; stabilizers are, for example, antioxidants, UV stabilizers or hydrolysis stabilizers; and antistats are, for example, quaternary ammonium compounds.

In addition to these the molding compound may optionally comprise further customary constituents, provided the effect according to the invention is substantially retained in such cases; examples include flame retardants, where necessary in any specific application.

The molding compound is produced from the individual components by means of conventional methods, normally by melt mixing in a kneading apparatus. It can be processed to moldings by means of customary technologies such as injection molding or extrusion. These moldings can be directly metallized by any known methods, both wet-chemically and by vacuum deposition, such as by vapor deposition, cathodic atomization (sputtering) or plasma CVD processes, for example. Prior to metallization, the polymer surface is optionally pretreated using techniques known to the skilled worker, such as vacuum glow discharge, for example. Generally speaking, the metal applied is chromium, nickel or, in particular, aluminum, and also so-called precious metals such as palladium, for example. The metal layer obtained in this way can subsequently be provided with an additional layer for increasing the scratch resistance, by means of coating or vacuum deposition processes, for instance, which make use, for example, of silicon compounds.

In this way the molding can be metallized either over its entire surface or else only over part of its surface, which in certain circumstances may be a minor part. “Metallized” in the sense of the claims, accordingly, encompasses the meaning of “partially metallized” as well.

The metallized moldings of the invention are distinguished by a uniformly mirror-reflecting and firmly adhering metal layer; migration of constituents, leading to misting, clouding or rainbow effects, does not take place, even during long-term service at high temperatures.

Metallized moldings of the invention are, for example, parts of lamps or indicator lights of any kind, or trim elements. Specifically they may be, in particular, headlamp surrounds and headlamp reflectors, trim elements as part of a headlamp surround, trim rings for example, or plates within headlamp surrounds, and also surrounds and reflectors of indicators or tail lights, and/or trim elements used therein or thereon. Besides automotive application, these molding compounds can be used generally for producing surrounds and reflectors of lamps or indicator lights, either in stationary operation or in other means of transport. In addition, one advantageous use that is possible is in the case of mirrors and reflectors in optical apparatus or instruments or devices for transmitting optical signals.

The invention is elucidated by way of example below.

In the examples the following materials are used:

Polyester A: A polybutylene terephthalate having a solution viscosity J of 110 ml/g to ISO 1628-5. Polyester A is prepared in a two-stage process. First a prepolymer having a solution viscosity J of 80 ml/g is produced by melt polycondensation. Thereafter a solid-phase postcondensation is performed to set the final viscosity level.

Polyester B: A polybutylene terephthalate having a solution viscosity J of 150 ml/g to ISO 1628-5. Polyester B is prepared in a two-stage process. First a prepolymer having a solution viscosity J of 105 ml/g is produced by melt polycondensation. Thereafter a solid-phase postcondensation is performed to set the final viscosity level.

Sabic LD 2308AN00: A low-density polyethylene (PE-LD) from Sabic (former trade name: Stamylan LD)

Elvaloy 2715 AC: A copolymer of ethene and ethyl acrylate containing 15% ethyl acrylate, from DuPont

Tegomer H-Si 6440: A block copolymer consisting of polycaprolactone and polydimethyl-siloxane, from Degussa

Tegomer PP-Si 401: A block copolymer consisting of polypropylene, polydimethylsiloxane, and polycaprolactone, from Degussa

Production of compounds

The compounds were produced on a Werner & Pleiderer ZSK 30 with a barrel temperature of 250° C. at 250 rpm. The throughput was 12 kg/h.

Production of injection-molded sheets

Injection-molded sheets with dimensions of 150×105×2 mm were produced on an Engel ES 600/150 with a melt temperature of 260° C. and a mold temperature of 80° C.

Metallizing

The injection-molded sheets were metallized by the sputtering technique, using a Dynamet 4V unit from Leybold. The thickness of the aluminum layer was approximately 55 to 60 mn.

Measurement of demolding pressure

The demolding pressure was measured on a Krauss-Maffei KM60/210A injection-molding machine. The melt temperature was 260° C. A sleeve was manufactured which had an internal diameter of 35 mm, a height of 35 mm, and a linear increase in wall thickness from the gate to the base (2 mm to 3.5 mm). The core had a diameter which remained the same over its height; in other words, it had no drafts. The internal mold pressure was recorded via a pressure transducer installed in the cavity, and at its maximum was 400 bar. After the cooling time of 20 s had elapsed the mold was opened and the molding demolded via a hydraulically actuated stripper plate. The changing pressure in the hydraulic cylinder during this operation was recorded. To determine a measurement for the demolding pressure, 30 individual values were recorded, and used to form an arithmetic mean. The demolding pressure was defined as the maximum of the plot up to the time at which an inductive position transducer was traversed. This position transducer was reached shortly before the maximum ejector stroke. After the maximum value, the pressure fell off again, illustrating the transition from sticking to slipping. At the same time, a thermocouple mounted in the core detected the core surface temperature prevailing at this time. It was 80° C. The force required for demolding is proportional to the demolding pressure thus measured and so allows different molding compounds to be compared in terms of their propensity to stick to the mold surface.

Measurement of Adhesion of the Al Coating

The adhesion of the Al coating was examined in accordance with the following procedure. A coated sheet was scored with a scalpel in the center of the sheet, to a length of approximately 5 cm, in parallel with the longest edge, in such a way that the Al layer was severed. The sheet was then placed on a fixed substrate. The cut was then overstuck in parallel with its course with a Tesa adhesive film 2 cm in width, so that areas of equal size were masked off to the right and to the left of the cut. The film was pressed on by hand, without any bubbles. A sufficient length of the Tesa tape was left standing to allow the film to be grasped for the subsequent test. The bond strength of the film was about 2 N/cm (width). Subsequently the film was peeled off by hand in the direction of the scored track, perpendicularly to the surface, at a speed of approximately 30 cm/s, while the other hand held the sample on the substrate. To assess the adhesion, consideration was given to the area overstuck along the cut. For this purpose, a visual estimate was made of the proportion of the area over which the coating had become detached. To pass the test, it was necessary for no detachment to have occurred.

Assessment of surface quality

The surface quality on metallized sheets was assessed by visual inspection on the basis of comparison specimens. The inspection took account of optical surface defects such as clouding, misting, rainbow effects, for example.

The ratings awarded were as follows:

1: no detectable surface defects

2: slight surface defects

3: distinct surface defects

4: severe surface defects

To pass the test a rating of 2 was required.

The results are shown in table 1.

TABLE 1
Inventive examples 1 to 4 and comparative examples A to C

| | Example | | | | | | |
|---|---|---|---|---|---|---|---|
| Formula | 1 | 2 | 3 | 4 | A*) | B*) | C*) |
| Polyester A | 99.65 | 97.6 | | 99 | | | |
| Polyester B | | | 99.7 | | 99 | 99 | 100 |
| Sabic LD 2308AN00 | | | | | 1 | | |
| Elvaloy 2715 AC | | | | | | 1 | |
| Tegomer H-SI 6440 | 0.35 | 2.4 | 0.3 | | | | |
| Tegomer PP-Si 401 | | | | 1 | | | |
| Demolding pressure (bar) | 56 | 17 | 52 | 19 | 82 | 59 | 101 |
| Adhesion of metallization (tape test after scoring; % detachment) | 0 | 0 | 0 | 0 | 15 | 5 | 0 |
| Surface quality by visual assessment (rating) | 1-2 | 2 | 1-2 | 1-2 | 3 | 2-3 | 1 |

*)corresponding to EP-A-1 298 172

1. The method of using for producing a metallized molding a molding compound which comprises the following components:
I. 50 to 99.98 parts by weight of thermoplastic polyesters,
II. 0.02 to 5 parts by weight of a copolymer which contains polysiloxane blocks and polyester blocks,
III. 0 to 49.98 parts by weight of further adjuvants, selected from further polymers, fillers and pigments, antistats, reinforcing agents, and stabilizers, the sum of all the parts by weight making 100.

2. The method of using as claimed in claim 1, wherein the copolymer is a polysiloxane-polylactone block copolymer of the formula 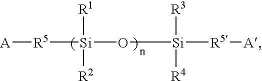
where n is an integer from 1 to about 200; R¹, R², R³, and R⁴, independently of one another, are a linear or branched alkyl radical having 1 to 6 carbon atoms;
A and A′, independently of one another, are units of the formula 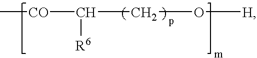
where p is an integer from 0 to 6; m is an integer from 1 to about 250;
R⁶ is hydrogen or a linear or branched alkyl group having 1 to 6 carbon atoms;
R⁵ is selected from —CH₂)_{q}—O—, —(CH₂)_{q}—NH—, —(CH₂)ₜ—O—(CH₂CH₂O)ᵥ—CH₂CH₂O—, and —(CH₂)ₜ—O—(CH₂CH₂O)ᵥ—CH₂CH₂NH—,
R⁵′ is selected from —O—(CH₂)_{q}—, —NH—(CH₂)_{q}—, —OCH₂CH₂—(OCH₂CH₂)ᵥ—O—(CH₂)ₜ—, and —HNCH₂CH₂—(OCH₂CH₂)ᵥ—O—(CH₂)ₜ—,
where q is an integer from 1 to 20,
t is an integer from 1 to 6, and
v is an integer from 1 to 100.

3. The method of using as claimed in claim 1, wherein the thermoplastic polyester is selected from the group consisting of polyethylene terephthalate, polypropylene terephthalate, polybutylene terephthalate, polyethylene 2,6-naphthalate, polypropylene 2,6-naphthalate, and polybutylene 2,6-naphthalate.

4. A metallized molding produced from the molding compound as set forth in claim 1.

5. The metallized molding as claimed in claim 4, which is part of a lamp, or is a trim element, a mirror or reflector of an optical apparatus or instrument, or part of a device for transmitting optical signals.
